(19) United States
(12) Patent Application Publication
(10) Pub. No.: US 2024/0065174 A1
(43) Pub. Date: Feb. 29, 2024

(54) VEGETATION HANGER

(71) Applicant: DriFlower, LLC, Ashland, OR (US)

(72) Inventor: Todd Chandler Larkins, Ashland, OR (US)

(21) Appl. No.: 17/766,802

(22) PCT Filed: Oct. 9, 2020
(86) PCT No.: PCT/US2020/054898

§ 371 Date: Apr. 6, 2022

Related U.S. Application Data
(60) Provisional application No. 62/913,058, filed on Oct. 9, 2019.

(51) Int. Cl. A01F 25/12

(52) U.S. Cl. CPC A01F 25/12

(57) ABSTRACT

A vegetation hanger includes a linear plate and an aperture. The linear plate includes a first edge, a second edge, a first end portion, and a second end portion. The first edge includes at least one ridge disposed along the first edge. The aperture is disposed centrally along the linear plate and configured to slidably engage with a bar.

### CROSS-REFERENCE TO RELATED APPLICATIONS

This application is a National Stage Application of PCT International Application No.: PCT/2020/054898 under 35 U.S.C. § 371(a), filed Oct. 9, 2020, which claims the benefit of, and priority to, U.S. Provisional Patent Application No. 62/913,058, filed on Oct. 9, 2019, the entire contents of each of which are hereby incorporated herein by reference.

### FIELD

The present disclosure generally relates to a hanger and more particularly, to a hanger for facilitating hang harvesting, transportation, drying and unloading of vegetation.

### BACKGROUND

Vegetation, such as plants, herbs, flowers, hemp and/or cannabis, and other vegetation, are harvested, and then subsequently dried to produce a final product. Typically, during the drying process, vegetation is hung on plastic netting, which causes stress to the user and damages vegetation. This process requires the vegetation to be hung one branch at time and threaded through the netting to secure the vegetation. Removal of the vegetation also requires careful unthreading of the vegetation one branch at a time from the plastic netting. Other methods have been contemplated, such as clothing hangers, bailing wires, string and/or ropes, screens, chains, cages, fencing, and combinations thereof, all of which cause damage to vegetation and stress to the user. Therefore, there is a need to provide a method of facilitating hang harvesting, transporting, drying and unloading of without damaging the vegetation.

### SUMMARY

The present disclosure relates to a hanger that includes a hanger portion and a crossbar coupled to the hanger portion to create a vegetation hanger to facilitate facilitating hang harvesting, transporting, drying and unloading of vegetation.

In one aspect, the present disclosure provides a vegetation hanger including a linear plate and an aperture. The linear plate has a first edge, a second edge, a first end portion, and a second end portion. The first edge includes at least one ridge disposed along the first edge. The aperture is disposed centrally along the linear plate and configured to slidably engage with a bar.

In aspects, the second edge of the linear plate may be bent at a predetermined angle relative to the crossbar.

In aspects, the predetermined angle may be 90 degrees.

In aspects, the first and second end portions of the linear plate each may include a lip.

In aspects, the linear plate may be tapered from a center point between the first and second end portions outwardly towards the first and second end portion.

In aspects, the vegetation hanger may be formed from one or more materials selected from metal, plastic, or composite materials.

In another aspect, the present disclosure provides a method of drying vegetation on a vegetation hanger. The method includes sliding a vegetation hanger includes onto a bar; hanging the vegetation on a first edge of a crossbar having at least one ridge disposed on the first edge; and carrying, via the bar, the vegetation from a first location to a second location.

In aspects, carrying the vegetation hanger to transport the vegetation may include transporting the vegetation from a point of harvest to a final drying location.

### BRIEF DESCRIPTION OF DRAWINGS

FIG. 1 is a front view of a vegetation hanger in accordance with the present disclosure; and

FIG. 2 is a top view of the hanger portion of the hanger of FIG. 1.

### DETAILED DESCRIPTION

Embodiments of the presently disclosed vegetation hanger are described in detail with reference to the drawings, in which like reference numerals designate identical or corresponding elements in each of the several views.

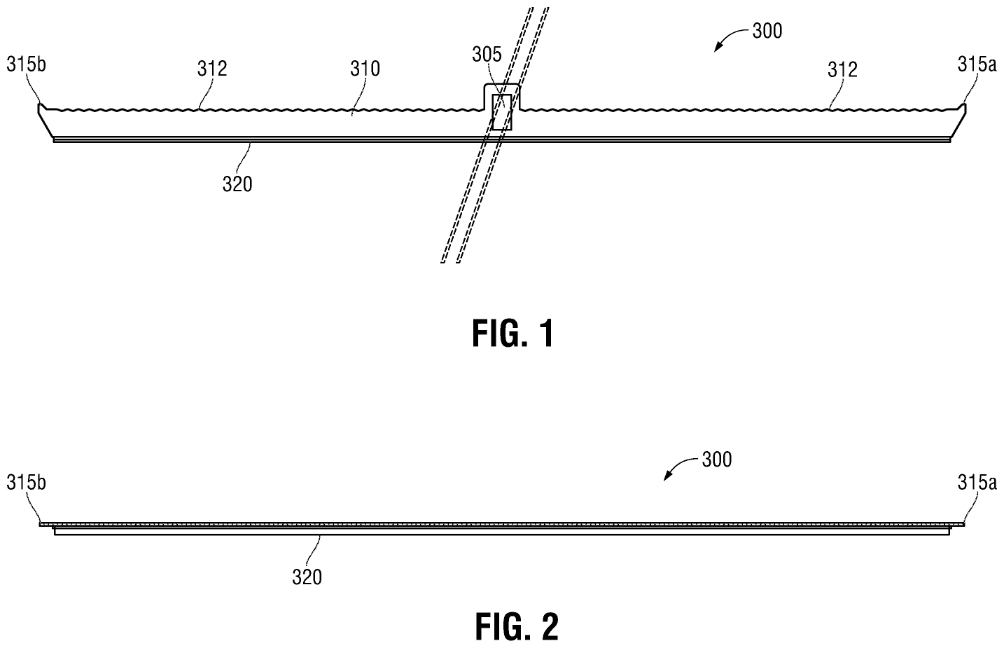

Referring to FIG. 1, a vegetation hanger provided in accordance with the present disclosure is shown generally identified by reference numeral 1. The vegetation hanger 1 generally includes a crossbar 300. The crossbar 300 includes a linear portion 310 and an aperture 305. The aperture 305 is disposed centrally along the linear portion 310 and configured to slidably engage a pole or horizontal bar. The linear plate 301 is configured to facilitate the hanging of vegetation thereon. The linear plate 301 includes a first end portion 300a and second end portion 300b, a top edge 300c, and bottom edge 300d. At least a portion of top edge 300c of the linear plate 301 includes at least one ridge, or alternatively as shown, serrated or textured surface including a series or plurality of ridges 312, disposed along the top edge 300c. The series of ridges are configured to prevent vegetation from sliding off the crossbar 300 and provide organization of the vegetation on the series of ridges 312. The linear plate 301 includes one or more lips 315a, 315b disposed on the first and second end portions 300a, 300b, respectively. The lips 315a, 315b are configured to prevent unintended lateral movement of the vegetation off the first and second end portion 300a, 300b. When intended, lateral movement of all the vegetation hung on the crossbar 300 at once may be initiated by a user. The crossbar 300 may be fabricated from a lightweight powdered metal, plastic, composite material, or any other suitable material. The aperture 305 is further configured to receive a zip tie or any suitable fasteners and the linear portion 310 is configured to receive a label disposed along the linear portion 310, in which both zip tie and the label contains harvest information such as, for example, name of harvest, strain, and/or date and time of harvest, in order to facilitate labeling of the harvest.

With additional reference to FIG. 2, the bottom edge 300d is configured to be bent to a predetermined angle such as, for example, 90 degrees, relative to the linear plate 301 to provide additional strength to the linear plate 301 in carrying vegetation on the linear plate 301.

The linear plate 301 may be fabricated at any suitable length, which, as non-limiting examples, may be one of 21″, 41″, or 61″ to accommodate different open spaces, amount of vegetation to be dried, and support of vegetation within a drying system. The vegetation hanger 1 may be configured to be flat providing a minimal thickness to allow for stacking and storage of multiple vegetation hanger(s). Alternatively, the linear plate 301 may be configured to be tapered in two directions from a center point between the first end portion 300a and the second end portion 300b outwardly towards each of the first end portion 300a and the second end portion 300b.

In operation to dry vegetation, the vegetation hanger(s) 1, including the crossbar 300, is slidably engaged with the pole or horizontal bar at the point of harvest. The vegetation may be cut (e.g., to about 24″ in length) and hung along the top edge 300c of the crossbar 300. Each piece of harvested vegetation can be placed between adjacent ridges of the series of ridges 312 to prevent individual movement of the vegetation. Once all the vegetation has been placed on the crossbar 300 of vegetation hanger 1, the vegetation hanger 1 may be carried (e.g., by a user) via the pole or horizontal bar from the point of harvest to the final drying location.

While several embodiments of the disclosure have been detailed above and are shown in the drawings, it is not intended that the disclosure be limited thereto, as it is intended that the disclosure be as broad in scope as the art will allow and that the specification be read likewise. Therefore, the above description and accompanying drawings should not be construed as limiting, but merely as exemplifications of particular embodiments. Those skilled in the art will envision other modifications within the scope and spirit of the claims appended hereto.

What is claimed is:

1. A vegetation hanger, comprising:
a linear plate having a first edge, a second edge, a first end portion, and a second end portion, wherein the first edge includes at least one ridge disposed along the first edge; and
an aperture disposed centrally along the linear plate and configured to slidably engage with a bar.

2. The vegetation hanger according to claim 1, wherein the second edge of the linear plate is bent at a predetermined angle relative to the linear plate.

3. The vegetation hanger according to claim 2, wherein the predetermined angle is 90 degrees.

4. The vegetation hanger according to claim 1, wherein the first and second end portions of the linear plate each includes a lip.

5. The vegetation hanger according to claim 1, wherein the linear plate is tapered from a center point between the first and second end portions outwardly towards the first and second end portion.

6. The vegetation hanger according to claim 1, wherein the vegetation hanger is formed from one or more materials selected from metal, plastic, or composite materials.

7. A method of drying vegetation on at least one vegetation hanger, the method comprising:
sliding at least one vegetation hanger onto a horizontal bar, wherein each vegetation hanger includes a linear plate defining a plurality of ridges;
cutting vegetation into strips;
hanging the strips of cut vegetation between adjacent ridges of the linear plate; and
carrying, via the horizontal bar, the strips of cut vegetation from a first location to a second location.

8. The method according to claim 7, wherein carrying the vegetation from a first location to a second location includes transporting the vegetation hanger from a point of harvest to a final drying location.
